(19) United States
(12) Patent Application Publication
(10) Pub. No.: US 2020/0153569 A1
(43) Pub. Date: May 14, 2020

(54) BASE STATION AND USER EQUIPMENT FOR FREQUENCY RANGE DETECTION

(71) Applicant: GUANGDONG OPPO MOBILE TELECOMMUNICATIONS CORP., LTD., Dongguan (CN)

(72) Inventor: Weijie XU, Dongguan (CN)

(73) Assignee: GUANGDONG OPPO MOBILE TELECOMMUNICATIONS CORP., LTD., Dongguan (CN)

(21) Appl. No.: 16/738,448

(22) Filed: Jan. 9, 2020

Related U.S. Application Data
(63) Continuation of application No. PCT/CN2019/073268, filed on Jan. 25, 2019.
(60) Provisional application No. 62/621,578, filed on Jan. 24, 2018.

(51) Int. Cl. H04L 5/00; G01S 7/02

(52) U.S. Cl. CPC H04L 5/0007; G01S 7/022

(57) ABSTRACT

Base station (101) is provided, comprising a frequency range setup device (003), a writing device (104), and a transmitting device (105), wherein the frequency range setup device is adapted to determine the frequency range to be used for a UE, wherein the frequency range setup device is adapted to communicate the frequency range to be used for a UE to the writing device, wherein the writing device is adapted to encode the frequency range to be used for a UE and to w the encoded information into a data structure, wherein the writing device is further adapted to forward the data structure to the transmitting, device and wherein the transmitting device is adapted to transmit the data structure.

### CROSS-REFERENCE TO RELATED APPLICATIONS

This application is a continuation of International Application No. PCT/CN2019/073268, filed on Jan. 25, 2019, which claims priority to U.S. Patent Application No. 62/621,578, filed on Jan. 24, 2018. The disclosure of the aforementioned applications is hereby incorporated by reference in their entireties.

### FIELD OF INVENTION

The present disclosure relates to the technical field of communication networks. In particular, the present disclosure relates to a base station, to a user equipment, to a method for transmitting information about a used frequency range, a method for receiving information about a used frequency range, to a program element and to computer-readable medium.

### PRIOR ART

A characteristic of 5G is the ability to support different devices and services with different performance and data traffic models such as IP data traffic, non-IP data traffic, and short data bursts such as for example in Internet of Things based applications. In such applications sensors may send data packages ranging in size from a small status update to streaming video, or modern telephones such as smart phones may generate widely varying amounts of data. In contrast to 4G, the architecture of 5G is not only designed for large amounts of data and thus also supports short data bursts without the need for lengthy signaling procedures before and after sending a small amount of data. Cloud applications like cloud robotics may perform computation in the network rather than in a device and therefore may require low end-to-end latencies and high data rates.

Different devices may also have different mobility requirements. Sensors embedded in infrastructure may be stationary during their entire usable life. Other devices may be stationary during active periods, but nomadic between activations or other devices may by fully mobile.

The document 3GPP TS 38.101-1 V15.0.0 (2017-12) with the title “3rd Generation Partnership Project; Technical Specification Group Radio Access Network; NR; User Equipment (UE) radio transmission and reception; Part 1: Range 1. Standalone (Release 15)” establishes the minimum RF characteristics and minimum performance requirements for NR. User Equipment (UE) operating on frequency Range 1.

The document 3GPP TS 38.211 V1.0.0 (2017-09) with the title “3rd Generation Partnership Project; Technical Specification Group Radio Access Network; NR; Physical channels and modulation (Release 15)” defines the time-frequency structure of an SS/PBCH block and a control-resource set (CORESET).

The document 3GPP TS 38.212 V1.2.0 (2017-11) with the title “3rd Generation Partnership Project; Technical Specification Group Radio Access Network; NR; Multiplexing and channel coding (Release 15)” describes PBCH (Physical Broadcast Channel) payload generation.

The document 3GPP TS 38.213 V15.0.0 (2017-12) with the title “3rd Generation Partnership Project; Technical Specification Group Radio Access Network; NR; Physical layer procedures for control (Release 15)” describes a cell search as a procedure by which a UE acquires time and frequency synchronization with a cell and detects the physical layer Cell ID of that cell.

The document 3GPP TS 38.331 V1.0.0 (2017-12) with the title “Technical Specification 3rd Generation Partnership Project Technical Specification Group Radio Access Network; NR; Radio Resource Control (RRC) Protocol specification (Release 15) specifies the Radio Resource Control protocol liar the radio interface between UE and NG-RAN (Next Generation—Radio Access Network).

Cell search may be a challenge with overlapping frequency ranges such as FR1 and FR2.

### SHORT DESCRIPTION OF INVENTION

It is an object of the present disclosure to provide for an efficient band detection.

In this text, a base station, a user equipment, a method for transmitting information about a used frequency range, a method for receiving information about a used frequency range, a program element and a computer-readable medium are provided.

The subject-matters of the present disclosure are provided in the independent claims. Features of further exemplary embodiments of the present disclosure are provided in the dependent claims.

According to an aspect of the present disclosure a base station is provided, comprising a frequency range setup device, a writing device and a transmitting device. The frequency range setup device is adapted to determine the frequency range to he used for a UE. The frequency range setup device is adapted to communicate the frequency range to be used for a UE to the writing device. The writing device is adapted to encode the frequency range to be used for a UE and to write the encoded information into a data structure. The writing device is further adapted to forward the data structure to the transmitting device and the transmitting device is adapted to transmit the data structure.

According to another aspect of the present disclosure a user equipment is provided, comprising a receiving device, a reading device and a frequency range detecting device. The receiving device is adapted to receive a data structure and m forward the data structure to the reading device. The reading device is adapted to read an encoded information about a frequency range and to decode a frequency range to be used for the UE. The frequency range detecting device is adapted to detect the frequency range from the decoded information and to use the detected frequency range for a communication with a base station.

According to another aspect of the present disclosure a method for transmitting information about a used frequency range is provided, comprising determining the frequency range to be used for a UE, encoding the frequency range to be used for a UE and writing the encoded information into a data structure and transmitting the data structure.

According to another aspect of the present disclosure a method for receiving information about a used frequency range is provided. The method comprises receiving a data structure, reading an encoded information about a frequency range and decoding a frequency range to be used for the UE. The method further comprises detecting the frequency range from the decoded information and using the detected frequency range for a communication with a base station.

According to another aspect of the present disclosure a program element is provided, which, when being executed by a processor is adapted to carry out one of the inventive methods.

According to another aspect of the present disclosure a computer-readable medium comprising program code is provided, which, when being executed by a processor is adapted to carry out one of the inventive methods.

A computer-readable medium may be a floppy disk, a hard disk, an USB (Universal Serial Bus) storage device, a RAM (Random Access Memory), a ROM (read only memory) or an EPROM (Erasable Programmable Read Only Memory). A computer readable medium may also be a data communication network, e.g. the Internet, which may allow downloading a program code.

According to another aspect of the present disclosure the frequency range setup device is adapted to determine the frequency range out of a group of at least two frequency ranges.

According to another aspect of die present disclosure the group of at least two frequency ranges comprises at least two overlapping frequency ranges.

According to another aspect of the present disclosure the data structure is a payload of a PBCH, e.g. a SSB. The term “SSB” is an abbreviation for a SS (Synchronization Signal)/PBCH block. The SS/PBCH block may be combination of PSS/SSS (Primary Synchronization Signal/Secondary Synchronization Signal). The SS/PBCH block is used for UE's synchronization (SYNC) to the network. The PBCH channel also comprises the MIB (Master Information Block).

According to another aspect of the present disclosure the frequency range is encoded as the carrier of the frequency range, as a configuration table for the frequency range, as a searching carrier and/or as a RMSI CORESET (Remaining Minimum SI (System Information) Control Resource Set).

A RMSI CORESET defines the time and frequency resources where the PDCCH (Physical Downlink Control Channel) schedules the PDSCH (Physical Downlink Shared Channel). In order to indicate the time and frequency resources the BS conveys the RMSI to the UE.

According to an aspect of the present disclosure methods are provided to enable the UE to determine whether the RMSI CORESET configuration tables are based on the ones for 5 MHz minimum channel bandwidth or the ones for 10 MHz minimum channel bandwidth in order to solve the above-identified problems.

In this way two tables may be designed, one table for minimum channel bandwidth of 5 MHz, and another table for a minimum channel bandwidth of 10 MHz. The tables provide the configurations for RMSI CORESET such as the bandwidth, the frequency location etc. Instead of using only one uniform table for a minimum channel bandwidth of 5 MHz or 10 MHz, separate tables are used, one table for 5 MHz and one table for 10 MHz. Thus, by choosing a specific table a minimum channel bandwidth of 5 MHz or 10 MHz can be selected.

For example, for frequency hands with minimum channel bandwidth 5 MHz or 10 MHz four different look up tables may be provided, such as Tables 13-1-13-4 of TS 38.213. One of the four lookup tables may be selected based on a detected subcarrier spacing. In an example subcarrier spacing of {15, 15} kHz for frequency bands with minimum channel bandwidth 5 MHz or 10 MHz selects a first table, subcarrier spacing of {15, 30} kHz for frequency bands with minimum channel bandwidth 5 MHz or 10 MHz selects a second table, subcarrier spacing of {30, 15} kHz for frequency bands with minimum channel bandwidth 5 MHz or 10 MHz selects a third table and subcarrier spacing of {30, 30} kHz for frequency bands with minimum channel bandwidth 5 MHz or 10 MHz selects a fourth table.

By using separate tables for 5 MHz and 10 MHz eight different lookup tables are provided.

According to one aspect of the present disclosure an embodiment is provided, where it is indicated in PBCH whether the RMSI CORESET is for carriers in Band n38 or for carriers in Band n41. In an example one reserved bit in PBCH payload or one used bit in PBCH payload can be used. In a more specific example, one of the 2 reserved SSB index indication bits for below 6 GHz may be used.

According to 3GPP TS 38.211 V1.0.0 a downlink physical channel corresponds to a set of resource elements carrying information originating from higher layers. The following downlink physical channels are defined: Physical Downlink Shared Channel (PDSCH), Physical Broadcast Channel (PBCH), and Physical Downlink Control Channel (PDCCH). In an example a PBCH may have 2 bits reserved.

According to 3GPP TS38.331 the MIB message comprises a sequence of elements. The elements of this sequence comprise the elements systemFrameNumber, subCarrierSpacingCommon, ssb-SubcarrierOffset, dmrs-TypeA-Position, pdcch-ConfigSIBI, cellBarred and intraFreqReselection. In addition, the MIB message comprises a spare element of the type bit siring which has a size of one bit. This spare element in the MIB message is one reserved bit for high-layer use and may be used to indicate the frequency range to be used. This spare element may be used to differentiate between minimum channel bandwidth 5 MHz and 10 MHz. There is also another bit for physical layer for future use.

In other words, the frequency range to be used for a UE is encoded to indicate the RMSI CORESET for carriers in a respective band. One bit of the 2 bits in the PBCH may be selected to differentiate the two frequency bands. Thus, one single bit may be enough, to differentiate between the two bands that may be overlapped at the same frequency range.

The base station (BS), e.g. a gNB, transmits the PBCH to the UE. In other words, the BS may transmit encoded information in a PBCH to the UE.

With this encoding the frequency range is encoded as the carrier of the frequency range.

For example, when the bit is set to “0”, it indicates the RMSI CORESET is for carriers in Band n38, then the UE decodes the RMSI based on the RMSI CORESET configuration tables for 5 MHz minimum channel bandwidth. For example, when the bit is set to “1”, it indicates the RMSI CORESET is for carriers in Band n41, then the UE decodes the RMSI based on the RMSI CORESET configuration tables for 10 MHz minimum channel bandwidth.

A band may comprise several carriers. Different bands may use different carrier or a different plurality of carrier. Thus, the combination of the different carrier in a plurality of carriers may allow for identifying the corresponding band. In an example Band n38 comprises a different plurality of carriers than Band n41.

In other words, one bit of SSB index indication bits, which are transmitted via PBCH are defined as to indicate, winch carriers are to be used by the UE, the carriers for band n38 or the carriers for band n41.

Thus, in one example the BS indicates in the information transmitted over PBCH the band to be selected and in particular the information whether the RMSI CORESET is for carriers in Band n38 or for carriers in band n41.

For PBCH contents the spare element of MIB is used. For the RMSI, a frequency and time location are configured in MIB. This scheme uses one bit in PBCH to indicate which band the UE is using. In this example the UE can derive the information about the band to be used, e.g. band n38 or band n41 by assessing the information provided to indicate whether the RMSI CORESET table used is for 5 MHz or 10 MHz. In the example, if the RMSI CORESET table is for 5 MHz the band n38 is used and if the RMSI CORESET table is for 10 MHz the band n41 is used.

According to one further aspect of the present disclosure a further embodiment of the disclosure is provided, where it is directly indicated in PBCH whether the RMSI CORESET is based on the RMSI CORESET configuration tables for 5 MHz minimum channel bandwidth or for 10 MHz minimum channel bandwidth. In an example one reserved bit in PBCH payload or one used bit in PBCH payload can be used. In a more specific example one of the 2 reserved SSB index indication bits for below 6 GHz may be used. Also, in this case a plurality of carrier may be used to indicate the desired band.

In other words, the frequency range to be used for a UE is encoded to indicate directly the RMSI CORESET and not the RMSI CORESET for carriers in a respective band.

The base station, e.g. gNB, transmits the PBCH to the UE. In other words, the BS may transmit encoded information in a PBCH to the UE.

With this encoding the frequency range is encoded as a configuration table for the frequency range.

For example, when the bit, e.g. the spare bit of MIB is set “0”. It indicates the RMSI CORESET configuration tables are based on the ones for 5 MHz minimum channel bandwidth. Otherwise, when the bit is set to “1”, it indicates the RMSI CORESET configuration tables are based on the ones for 10 MHz minimum channel bandwidth. The RMSI CORESET configuration tables may be referred to as lookup tables as described above.

In such an example the BS directly indicates by the information transmitted in the PBCH the table to be selected and in particular the transmitted information indicates whether the RMSI CORESET is based on the RMSI CORESET configuration tables for 5 MHz minimum channel bandwidth or for 10 MHz minimum channel bandwidth.

According to yet another aspect of the present disclosure yet another embodiment of the present disclosure is provided, where it is indicated in PBCH whether the current searching carriers are in Band n38 or in carriers in band n41. In an example one reserved bit in PBCH payload or one used bit in PBCH payload can be used.

The term “below 6 GHz” may refer to the position of a selected frequency band within a large frequency band. In other words, the selected frequency bands may lie and/or are positioned below a frequency of 6 GHz. In the frequency band below 6 GHz, two bits may be reserved which may be used for SSB index indication for above 6 GHZ.

The base station, e.g. gNB, transmits the PBCH to the UE. In other words, the BS may transmit encoded information in a PBCH to the UE.

For example, when the bit is set to “0”, it indicates current searching carriers are in Band n38, then the UE decodes the RMSI based on the RMSI CORESET configuration tables for 5 MHz minimum channel bandwidth. For example, when the bit is set to “1”, current searching carriers are in Band n41, then the UE decodes the RMSI based on the RMSI CORESET configuration tables for 10 MHz minimum channel bandwidth.

The present disclosure provides methods to enable the UE to determine whether the RMSI CORESET configuration tables are based on the ones for 5 MHz minimum channel bandwidth or the ones for 10 MHz minimum channel bandwidth. Based on this method, when UE reads RMSI based on the RMSI CORESET indication in the PBCH, the UE can use the right RMSI CORESET configuration table when the UE perform cell search in the overlapping frequency range between Band n38 and Band n41 for NR. Thus, the correct RMSI CORESET configuration table can be used.

According to another aspect of the present disclosure the frequency range detecting device is adapted to determine the frequency range out of a group of at least two frequency ranges.

According to another aspect of the present disclosure the frequency range is decoded as the carrier of the frequency range, as a configuration table for the frequency range, as a searching carrier and/or as a RMSI CORESET.

In an example an RMSI CORESET configuration tables indication device and/or method is provided.

It has to be noted that aspects of the disclosure have been described with reference to different subject-matters. In particular, some aspects have been described with reference to apparatus type claims whereas other aspects have been described with reference to method type claims. However, a person skilled in the an will gather from the above and the following description that, unless other notified, in addition to any combination between features belonging to one type of subject-matter also any combination between features relating to different types of subject-matters is considered to be disclosed with this text. In particular, combinations between features relating to the apparatus type claims and features relating to the method type claims are considered to be disclosed.

### SHORT DESCRIPTION OF DRAWINGS

Further embodiments of the disclosure are described in the following description of the Figures. The disclosure will be explained in the following in detail by means of embodiments and with reference to the drawing in which is shown:

FIG. 1 shows a communication system according to an exemplary embodiment of the present disclosure.

FIG. 2 shows an SSB or SS/PBCH block for a better understanding of the present disclosure.

### DETAILED DESCRIPTION

In the following the same reference numerals will be used for parts having the same or equivalent function. Any statements made having regard to the direction of a component are made relative to the position shown in the drawing and can naturally vary in the actual position of application.

NR is designed to operate in the FR1 (450 MHz-6000 MHz) operating bands defined in the following table 5.2-1 as specified in 3GPP specification 38.133-1-f00 and/or in 3GPP specification 38.101-1-f100.

In other words, Frequency range 1 (FR1) reaches from 450 MHz to 6000 MHz and therefore may also be named Sub 6 GHz range.

Table 1 shows NR operating bands in FR1 according to Table 5.2-1 of 3GPP 38.101-1-f100.

TABLE 1

| | Uplink (UL) | Downlink (DL) | |
|---|---|---|---|
| | operating band | operating band | |
| NR | BS receive | BS transmit | |
| Operating | UE transmit | UE receive | Duplex |
| Band | F_{UL}_{_{—}}_{low}-F_{UL}_{_{—}}_{high} | F_{DL}_{_{—}}_{low}-F_{UL}_{_{—}}_{high} | Mode |
| n1 | 1920 MHz-1980 MHz | 2110 MHz-2170 MHz | FDD |
| n2 | 1850 MHz-1910 MHz | 1930 MHz-1990 MHz | FDD |
| n3 | 1710 MHz-1785 MHz | 1805 MHz-1880 MHz | FDD |
| n5 | 824 MHz-849 MHz | 869 MHz-894 MHz | FDD |
| n7 | 2500 MHz-2570 MHz | 2620 MHz-2690 MHz | FDD |
| n8 | 880 MHz-915 MHz | 925 MHz-960 MHz | FDD |
| n20 | 832 MHz-862 MHz | 791 MHz-821 MHz | FDD |
| n28 | 703 MHz-748 MHz | 758 MHz-803 MHz | FDD |
| n38 | 2570 MHz-2620 MHz | 2570 MHz-2620 MHz | TDD |
| n41 | 2496 MHz-2690 MHz | 2496 MHz-2690 MHz | TDD |
| n50 | 1432 MHz-1517 MHz | 1432 MHz-1517 MHz | TDD |
| n51 | 1427 MHz-1432 MHz | 1427 MHz-1432 MHz | TDD |
| n66 | 1710 MHz-1780 MHz | 2119 MHz-2200 MHz | FDD |
| n70 | 1695 MHz-1710 MHz | 1995 MHz-2020 MHz | FDD |
| n71 | 663 MHz-698 MHz | 617 MHz-652 MHz | FDD |
| n74 | 1427 MHz-1470 MHz | 1475 MHz-1518 MHz | FDD |
| n75 | N/A | 1432 MHz-1517 MHz | SDL |
| n76 | N/A | 1427 MHz-1432 MHz | SDL |
| n78 | 3300 MHz-3800 MHz | 3310 MHz-3800 MHz | TDD |
| n77 | 3300 MHz-4200 MHz | 3300 MHz-4200 MHz | TDD |
| n79 | 4400 MHz-5000 MH | 4400 MHz-5000 MHz | TDD |
| n80 | 1710 MHz-1785 MHz | N/A | SUL |
| n81 | 880 MHz-915 MHz | N/A | SUL |
| n82 | 832 MHz-862 MHz | N/A | SUL |
| n83 | 703 MHz-748 MHz | N/A | SUL |
| n84 | 1920 MHz-1989 MHz | N/A | SUL |

It can be seen in the table that Band n38 and band n41 are partially overlapped, i.e., the frequencies in band n38 are included in band n41. Band n38 spans a range of 2570 MHz-2620 MHz for uplink (UL) and 2570 MHz-2620 MHz for the downlink (DL). Band n41 spans a range of 2496 MHz-2690 MHz for uplink and 2496 MHz-2690 MHz for downlink. The Uplink (UL) operating band is the band where BS receives, and UE transmit. The Downlink (DL) operating band is the band where BS transmits, and UE receives.

Furthermore, the channel bandwidths for each NR (New Radio) band are specified as in the following Table 2 as specified in 3GPP specification 38.133-1-f00 and/or in 3GPP specification 38.101-1-f00, it can be seen that the minimum bandwidth for band n38 is 5 MHz while the minimum bandwidth for band n41 is 10 MHz.

Table 2 corresponds to Table 5.3.5-1 of 3GPP 38.101-1-f00 and indicates channel bandwidths for each NR band.

TABLE 2
NR band/SCS/UE Channel bandwidth

| NR | SCS | 5 | 10^{1,2} | 15² | 20² | 25² | 30 | 40 | 50 | 60 | 80 | 100 |
|---|---|---|---|---|---|---|---|---|---|---|---|---|
| Band | kHz | MHz | MHz | MHz | MHz | MHz | MHz | MHz | MHz | MHz | MHz | MHz |
| n1 | 15 | Yes | Yes | Yes | Yes | | | | | | | |
| | 30 | | Yes | Yes | Yes | | | | | | | |
| | 60 | | Yes | Yes | Yes | | | | | | | |
| n2 | 15 | Yes | Yes | Yes | Yes | | | | | | | |
| | 30 | | Yes | Yes | Yes | | | | | | | |
| | 60 | | Yes | Yes | Yes | | | | | | | |
| n3 | 15 | Yes | Yes | Yes | Yes | Yes | Yes | | | | | |
| | 30 | | Yes | Yes | Yes | Yes | Yes | | | | | |
| | 60 | | Yes | Yes | Yes | Yes | Yes | | | | | |
| n5 | 15 | Yes | Yes | Yes | Yes | | | | | | | |
| | 30 | | Yes | Yes | Yes | | | | | | | |
| | 60 | | | | | | | | | | | |
| n7 | 15 | Yes | Yes | Yes | Yes | | | | | | | |
| | 30 | | Yes | Yes | Yes | | | | | | | |
| | 60 | | Yes | Yes | Yes | | | | | | | |
| n8 | 15 | Yes | Yes | Yes | Yes | | | | | | | |
| | 30 | | Yes | Yes | Yes | | | | | | | |
| | 60 | | | | | | | | | | | |
| n20 | 15 | Yes | Yes | Yes | Yes | | | | | | | |
| | 30 | | Yes | Yes | Yes | | | | | | | |
| | 60 | | | | | | | | | | | |
| n28 | 15 | Yes | Yes | Yes | Yes | | | | | | | |
| | 30 | | Yes | Yes | Yes | | | | | | | |
| | 60 | | | | | | | | | | | |
| n38 | 15 | Yes | Yes | Yes | Yes | | | | | | | |
| | 30 | | Yes | Yes | Yes | | | | | | | |
| | 60 | | Yes | Yes | Yes | | | | | | | |
| n41 | 15 | | Yes | Yes | Yes | | | Yes | Yes | | | |
| | 30 | | Yes | Yes | Yes | | | Yes | Yes | Yes | Yes | Yes |
| | 60 | | Yes | Yes | Yes | | | Yes | Yes | Yes | Yes | Yes |
| n50 | 15 | Yes | Yes | Yes | Yes | | | Yes | Yes | | | |
| | 30 | | Yes | Yes | Yes | | | Yes | Yes | Yes | Yes | |
| | 60 | | Yes | Yes | Yes | | | | | | | |
| n51 | 15 | Yes | | | | | | | | | | |
| | 30 | | | | | | | | | | | |
| | 60 | | | | | | | | | | | |
| n66 | 15 | Yes | Yes | Yes | Yes | | | | | | | |
| | 30 | | Yes | Yes | Yes | | | Yes | | | | |
| | 60 | | Yes | Yes | Yes | | | Yes | | | | |
| n70 | 15 | Yes | Yes | Yes | Yes | Yes | | | | | | |
| | 30 | | Yes | Yes | Yes | Yes | | | | | | |
| | 60 | | Yes | Yes | Yes | Yes | | | | | | |
| n71 | 15 | Yes | Yes | Yes | Yes | | | | | | | |
| | 30 | | Yes | Yes | Yes | | | | | | | |
| | 60 | | | | | | | | | | | |
| n74 | 15 | Yes | Yes | Yes | Yes | | | | | | | |
| | 30 | | Yes | Yes | Yes | | | | | | | |
| | 60 | | Yes | Yes | Yes | | | | | | | |
| n75 | 15 | Yes | Yes | Yes | Yes | | | | | | | |
| | 30 | | Yes | Yes | Yes | | | | | | | |
| | 60 | | Yes | Yes | Yes | | | | | | | |
| n76 | 15 | Yes | | | | | | | | | | |
| | 30 | | | | | | | | | | | |
| | 60 | | | | | | | | | | | |
| n77 | 15 | | Yes | | Yes | | | Yes | Yes | | | |
| | 30 | | Yes | | Yes | | | Yes | Yes | Yes | Yes | Yes |
| | 60 | | Yes | | Yes | | | Yes | Yes | Yes | Yes | Yes |
| n78 | 15 | | Yes | | Yes | | | Yes | Yes | | | |
| | 30 | | Yes | | Yes | | | Yes | Yes | Yes | Yes | Yes |
| | 60 | | Yes | | Yes | | | Yes | Yes | Yes | Yes | Yes |
| n79 | 15 | | | | | | | Yes | Yes | | | |
| | 30 | | | | | | | Yes | Yes | Yes | Yes | Yes |
| | 60 | | | | | | | Yes | Yes | Yes | Yes | Yes |
| n80 | 15 | Yes | Yes | Yes | Yes | Yes | Yes | | | | | |
| | 30 | | Yes | Yes | Yes | Yes | Yes | | | | | |
| | 60 | | Yes | Yes | Yes | Yes | Yes | | | | | |
| n81 | 15 | Yes | Yes | Yes | Yes | | | | | | | |
| | 30 | | Yes | Yes | Yes | | | | | | | |
| | 60 | | | | | | | | | | | |
| n82 | 15 | Yes | Yes | Yes | Yes | | | | | | | |
| | 30 | | Yes | Yes | Yes | | | | | | | |
| | 60 | | | | | | | | | | | |
| n83 | 15 | Yes | Yes | Yes | Yes | | | | | | | |
| | 30 | | Yes | Yes | Yes | | | | | | | |
| | 60 | | | | | | | | | | | |
| n84 | 15 | Yes | Yes | Yes | Yes | | | | | | | |
| | 30 | | Yes | Yes | Yes | | | | | | | |
| | 60 | | Yes | Yes | Yes | | | | | | | |

NOTE 1: 90% spectrum utilization may not be achieved for 30 kHz SCS.
NOTE 2: 90% spectrum utilization may not be achieved for 60 kHz SCS.

The challenge is that for different minimum channel bandwidths, NR needs to design different RMSI CORESET configuration tables to give the RMSI CORESET configurations. Moreover, the RMSI CORESET configuration index in the RMSI CORESET configuration table will be indicated to the UE by PBCH channel within the SS/PBCH block.

In other words, the RMSI CORESET configuration index in the RMSI CORESET configuration table will be transmitted to the UE via the PBCH channel within the SS/PBCH block.

In the current stage, NR has already defined the RMSI CORESET table for 5 MHz minimum channel bandwidth case as specified in 3GPP specification 38.213-f00, but RMSI CORESET table for 10 MHz minimum channel bandwidth case is still being discussed. When UE performs initial cell search in the frequency range [2570 MHz-2620 MHz], the UE doesn't know whether the RMSI is transmitted based on the RMSI CORESET configuration tables for 5 MHz minimum channel bandwidth or based on the RMSI CORESET configuration tables for 10 MHz minimum channel bandwidth, because frequency range [2570 MHz-2620 MHz] may be in Band n38 in which case the RMSI CORESET configuration table for 5 MHz minimum channel bandwidth shall be used or in Band n41 in which case the RMSI CORESET configuration table for 10 MHz minimum channel bandwidth shall be used. One implementation method can be based on UE's blindly detection, but the complexity would be high.

Therefore, this text shows how to inform and/or to indicate the UE how to determine the RMSI CORESET configuration tables to be used when receiving RMSI.

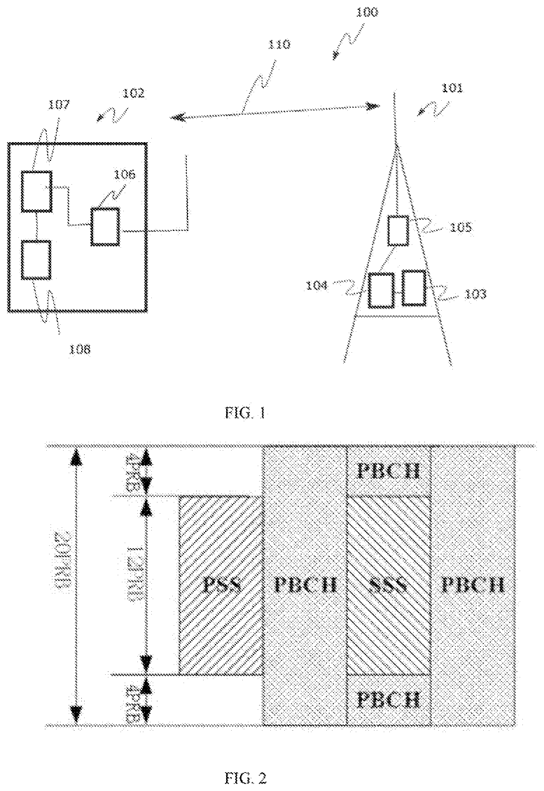

FIG. 1 shows a communication system 100 according to an exemplary embodiment of the present disclosure. The communication system 100 comprises the base station 101 which has a communication connection 110 to user equipment (UE) 102.

The base station 101 comprises a frequency range setup device 103, a writing device 104, a transmitting device 105 or transmitter 105. The frequency range setup device 103 is adapted to determine the frequency range to be used for the UE 102. If a UE wants to use a certain cell of a BS the UE needs to agree with the BS a frequency and/or time range on which it can communicate with the BS. If the UE supports multiple frequency ranges, the UE will search all of its frequency ranges until it finds the network and camps on the corresponding cell.

The frequency range setup device 103 communicates the frequency range to be used for a UE to the writing device 104. The writing, device encode the frequency range to be used for a communication with the UE 102 and writes the encoded information into a data structure, e.g., into a payload of a PBCH (Physical Broadcast Channel). In an example, such a data structure is a MIB (Master Information Block) transmitted in the PBCH as described in 3GPP specification TS 38.331 V1.0.0.

The MIB message or MIB data structure comprises system information transmitted on BCH (Broadcast Channel). This message does not use a signaling radio bearer. The RLC-SAP (Radio Link Control—Service Access Point) uses a transparent mode (TM). The MIB message or MIB data structure is transmitted over the logical channel BCCH from the network, e.g. BS, to the UE.

The MIB message or data structure has the following format written in the ASN1START specification language.

| | |
|---|---|
| MIB ::= | SEQUENCE { |

| | |
|---|---|
| systemFrameNumber | BIT STRING (SIZE (6)), |
| subCarrierSpacingCommon | ENUMERATED {scs15or60, |
| scs30or120}, | |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, |
| | notAllowed}, |
| spare | BIT STRING (SIZE (1) |
| | } |

In the MIB message the field “cellBarred” indicates that a cell is barred. The field “dmrs-TypeA-Position” comprises the position of (first) DM-RS (Demodulation-Reference Signal) for downlink and uplink. The field “intraFreqReselection” controls cell selection/reselection to intra-frequency cells when the highest ranked cell is barred or treated as barred by the UE.

The filed “pdcch-ConfigSIB1” of the “MIB” message determines a common ControlResourceSet (CORESET) a common search space and necessary PDCCH parameters.

If the field “ssb-SubcarrierOffset” indicates that SIB1 is not present, the field “pdcch-ConfigSIB1” indicates the frequency positions where the UE may find SS/PBCH block with SIB1 or the frequency range where the network does not provide SS/PBCH block with SIB1.

The field “ssb-SubcarrierOffset” corresponds to kSSB, which is the frequency domain offset between SSB and the overall resource block grid in number of subcarriers. kSSB refers to the offset between the SSB PRB grid and the common PRB grid. The value range of this field “ssb-SubcarrierOffset” may be extended by an additional most significant bit encoded within PBCH. This field “ssb-SubcarrierOffset” may indicate that a beam does not provide SIB1 and that there is hence no common CORESET. In this case, the field “pdcch-ConfigSIB1” may indicate the frequency positions where the UE may (not) find a SS/PBCH with a control resource set and search space for SIB1.

The field “subCarrierSpacingCommon” comprises the subcarrier spacing for SIB1, Msg.2/4 for initial access and broadcast SI-messages. “subCarrierSpacingCommon” indicates the subcarrier used for SIB1. If the UE acquires this MIB on a carrier frequency <6 GHz, i.e. below 6 GHz, the value scs15or60 corresponds to 15 Khz and the value scs30or120 corresponds to 30 kHz. If the UE acquires this MIB on a carrier frequency >6 GHz, i.e. above 6 GHz, the value scs15or60 corresponds to 60 kHz and the value scs30or120 corresponds to 120 kHz. This value indicates which subcarrier is used. For example, scs15 indicates that a 15 kHz subcarrier is used.

The field “systemFrameNumber” refers to the 6 most significant bit (MSB) of the 10-bit System Frame Number (SFN). The 4 least significant bit (LSB) of the SFN are conveyed in the PBCH transport block as part of channel coding, i.e. outside the MIB encoding.

The writing device 104 forwards the data structure or MIB message to the transmitting device 105 and the transmitting device 105 transmits the data structure to the UE 102. The MIB message has two reserved bits which can be used to indicate and/or to encode the frequency range. Since only two frequency ranges are to be distinguished one of the two reserved bits may be selected. In an example the spare bit of the MIB data structure may be used. Even here only the spare bit in MIB has been described, in general, there are two spare bits in PBCH which can equally be used for the indication of the band. By using a bit, in particular by changing the value of a bit in the PBCH, information about the band may be exchanged between BS 101 and UE 102.

The User equipment (UE) 102 comprises a receiving device 106 or receiver 106, a reading device 107 and a frequency range detecting device 108. The receiving device 106 receives a data structure and forwards the data structure to the reading device 107. The reading device 107 is adapted to read an encoded information about a frequency range and to decode a frequency range to be used for the UE. The frequency range detecting device 108 is adapted to detect the frequency range from the decoded information and to use the detected frequency range for a communication with a base station.

FIG. 2 shows an SSB or SS/PBCH block for a better understanding of the present disclosure. The SSB or SS/PBCH block comprises a plurality of contiguous resource blocks (Physical Resource Block, PRB).

It should be noted that the term “comprising” does not exclude other elements or steps and the “a” or “an” does not exclude a plurality. Also, elements described in association with different embodiments may be combined.

It should also be noted that reference signs in the claims shall not be construed as limiting the scope of the claims.

### LIST OF REFERENCE NUMERALS

100 Communication System

101 Base Station

102 User Equipment

103 Frequency Range Setup Device

104 Writing Device

105 Transmitting Device, Transmitter

106 Receiving Device, Receiver

107 Reading Device

108 Frequency Range Detecting Device

110 Communication Connection

What is claimed is:

1. A base station comprising:
a frequency range setup device:
a writing device;
a transmitting device;
wherein the frequency range setup device is adapted to determine the frequency range to be used for a user equipment (UE);
wherein the frequency range setup device is adapted to communicate the frequency range to be used for a UE to the writing device;
wherein the writing device is adapted to encode the frequency range to be used for a user equipment and to write the encoded information into a data structure,
wherein the writing device is further adapted to forward the data structure to the transmitting device;
wherein the transmitting device is adapted to transmit the data structure.

2. The base station of claim 1, wherein the frequency range setup device is adapted to determine the frequency range out of a group of at least two frequency ranges.

3. The base station of claim 2, wherein the group of at least two frequency ranges comprises at least two overlapping frequency ranges.

4. The base station of claim 1, wherein the data structure is a payload of a physical broadcast channel (PBCH).

5. The base station of claim 4, wherein the data structure is a synchronization signal (SS)/PBCH block (SSB).

6. The base station of claim 1, wherein the frequency range is encoded as at least one of: the carrier of the frequency range, a configuration table for the frequency range, a searching carrier or a remaining minimum system information control resource set (RMSI CORESET).

7. A user equipment, comprising:
a receiving device;
a reading device;
a frequency range detecting device;
wherein the receiving device is adapted to receive a data structure and to forward the data structure to the reading device;
wherein the reading device is adapted to read an encoded information about a frequency range and to decode a frequency range to be used for the user equipment;
wherein the frequency range detecting device is adapted to detect the frequency range from the decoded information and to use the detected frequency range for a communication with a base station.

8. The user equipment of claim 7, wherein the frequency range detecting device is adapted to determine the frequency range out of a group of at least two frequency ranges.

9. The user equipment of claim 7, wherein the data structure is a payload of a physical broadcast channel (PBCH).

10. The user equipment of claim 9, wherein the data structure is a synchronization signal (SS)/PBCH block (SSB).

11. The user equipment of claim 7, wherein the frequency range is decoded as at least one of: the carrier of the frequency range, a configuration table for the frequency range, a searching carrier or a remaining minimum system information control resource set (RMSI CORESET).

12. A method for receiving information about a used frequency range, comprising:
receiving a data structure;
reading an encoded information about a frequency range and decoding a frequency range to be used for the user equipment;
detecting the frequency range from the decoded information and using the detected frequency range for a communication with a base station.

13. The method of claim 12, wherein the method comprising: determining the frequency range out of a group of at least two frequency ranges.

14. The method of claim 12, wherein the data structure is a payload of a physical broadcast channel (PBCH).

15. The method of claim 14, wherein the data structure is a synchronization signal (SS)/PBCH block (SSB).

16. The method of claim 12, wherein the frequency range is decoded as at least one of: the carrier of the frequency range, a configuration table for the frequency range, a searching carrier or a remaining minimum system information control resource set (RMSI CORESET).

17. A program element, which when being executed by a processor is adapted to carry out the method of claim 12.

18. A non-volatile computer-readable medium comprising program code, which when being executed by a processor is adapted to carry out the method of claim 12.
